(19) United States
(12) Patent Application Publication
(10) Pub. No.: US 2020/0021089 A1
(43) Pub. Date: Jan. 16, 2020

(54) COATING REMOVING DEVICE

(71) Applicant: Yazaki Corporation, Tokyo (JP)

(72) Inventor: Mamoru Araki, Shizuoka (JP)

(21) Appl. No.: 16/431,993

(22) Filed: Jun. 5, 2019

(30) Foreign Application Priority Data
Jul. 10, 2018 (JP) 2018-130557

(51) Int. Cl. H02G 1/12

(52) U.S. Cl. CPC H02G 1/1263; B26D 3/28; H02G 1/127

(57) ABSTRACT

A coating removing device is provided which enables an improved operation efficiency of a middle-stripping operation of a coating element. The coating removing device comprises a circumferential cutter and a longitudinal cutter. The coating element is cut at two locations by the circumferential cutter to form two circumferential cut lines and the coating element is cut between the two circumferential cut lines by the longitudinal cutter so that the coating element can be removed between the two circumferential cut lines from the coated electric wire. This enables an automation of the middle-stripping operation of the coating element and improvement of the operation efficiency.

### BACKGROUND OF THE INVENTION

### Technical Field of the Invention

The present invention relates to a coating removing device for removing a part of a coating element on a coated electric wire.

### Background Art

Generally for coated electric wires, a conductor may be exposed by removing a part of a coating element so that a terminal metal part may be connected to the exposed conductor. A location from which the coating element is removed may be set not only at ends but also in a middle section of the coated electric wire (i.e. the coating element may be middle-stripped). This means that a conductor-exposed area which is disposed between coated areas may be formed by removing a part of the coating element on the coated electric wire. As a method for removing the coating element in the middle section of the coated electric wire in this manner, a method is proposed in which a cutting blade for stripping off coating is used, the cutting blade comprising a middle-stripping blade (e.g. see Patent Literature 1). According to the method of the Patent Literature 1, an operator removes the coating element by a manual operation combining of the electric wire guide with the cutting blade for stripping off coating.

### CITATION LIST

### Patent Literature

Patent Literature 1: JP 2015-2611A

### SUMMARY OF THE INVENTION

However, since the method according to the Patent Literature 1 is performed in a manual manner, the time required for the operation tends to be long, particularly in case of a poor experienced operator, the operation may take a longer time or defective products may occur. Therefore, improvement of the operation efficiency for the middle-stripping operation of the coating element has been desired.

The object of the invention is to provide a coating removing device which enables improvement of the operation efficiency for middle-stripping operation of a coating element.

A coating removing device according to the present invention wherein a conductor-exposed area is formed by removing a part of the coating element on the coated electric wire so that said conductor-exposed area is disposed in a longitudinal direction between coated areas, is characterized in that said coating removing device includes a circumferential cutter for cutting the coating element along a circumferential direction of the coated electric wire and a longitudinal cutter for cutting the coating element along the longitudinal direction, wherein said circumferential cutter includes a pair of first cutting blades for clamping the coated electric wire in a radial direction and a rotator for relatively rotating the pair of first cutting blades and the coated electric wire around a rotation axis along the longitudinal direction, wherein the longitudinal cutter includes at least one second cutting blade coming into contact with the coating element, and a linear translation unit for relatively displacing the second cutting blade and the coated electric wire along the longitudinal direction, wherein the coating element is cut at two locations by the circumferential cutter and cut between said two locations by the longitudinal cutter.

According to such a coating removing device of the present invention, an area surrounded by cut lines is formed in the coating element by cutting it at two locations by the circumferential cutter and by cutting the coating element between these two locations by the longitudinal cutter so that the coating element can be removed from the coated electric wire in this area. As a consequence, the middle-stripping operation of a coating element can be automated and improvement of the operation efficiency can be achieved. In this context, the timing for cutting by the circumferential cutter and the timing for cutting by the longitudinal cutter may be set in any suitable manner. Namely, it is possible to cut the coating element at two locations by the circumferential cutter and thereafter by the longitudinal cutter, to cut it by the longitudinal cutter and thereafter at two locations by the circumferential cutter, or also possible to cut it by the longitudinal cutter while cutting at two locations by the circumferential cutter.

### BRIEF DESCRIPTION OF THE DRAWINGS

FIG. 1 is a side view showing an overview of a coating removing device according to an embodiment of the present invention;

FIG. 2 is a perspective view of a coated electric wire before a coating element is removed by said coating removing device;

FIG. 3 is a perspective view of a coated electric wire after the coating element has been removed by said coating removing device;

FIG. 4 is a front view showing a circumferential cutter of said coating removing device;

FIG. 5 is a front view showing said circumferential cutter when being applied to a thick coated electric wire;

FIG. 6 is a front view showing a longitudinal cutter of said coating removing device;

FIG. 7 is a side view showing said longitudinal cutter;

FIG. 8 is a front view showing said longitudinal cutter when being applied to a thick coated electric wire;

FIG. 9 is a side view showing said longitudinal cutter when being applied to a thick coated electric wire;

FIG. 10 is a perspective view showing that a cut line was formed in said coated electric wire; and

FIG. 11 is a section view showing that a cut line was formed in said coated electric wire.

### DETAILED DESCRIPTION OF THE PREFERRED EMBODIMENTS

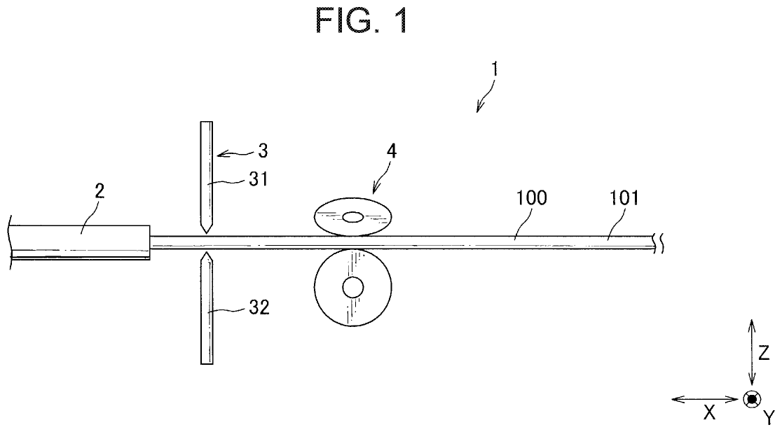

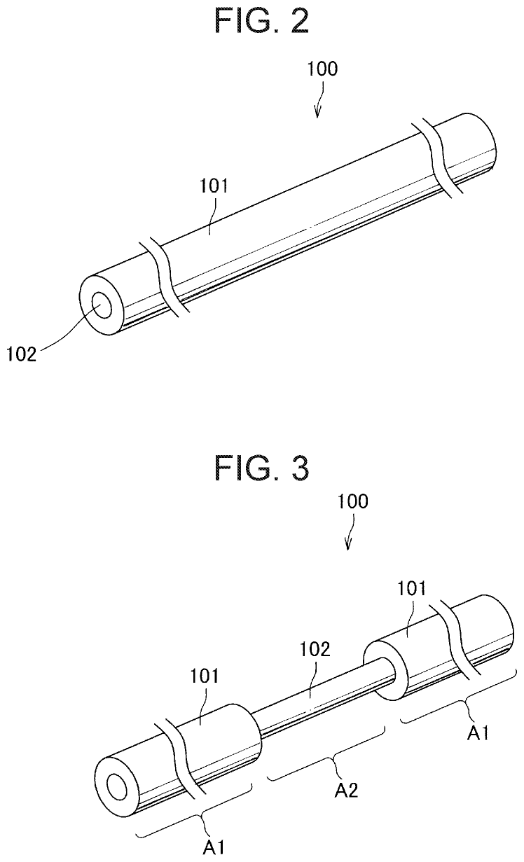

As shown in FIG. 1, a coating removing device 1 according to the present embodiment includes an electric wire sending means 2, a circumferential cutter 3 and a longitudinal cutter 4 wherein the coating removing device 1 cuts and removes a part of the coating element 101 on the coated electric wire 100 (middle-stripping). The coating removing device 1 removes the coating element 101 in a longitudinally middle section of the electric wire 100 as shown in FIG. 2 in order to form a conductor-exposed area A2 between two coated areas A1 with the conductor section 102 being exposed as shown in FIG. 3, wherein the conductor section 102 is coated with a coating element 101 in the two coated areas A1. Namely, the coating removing device 1 forms in the coated electric wire 100 the conductor-exposed area A2 which is disposed longitudinally between the coated areas A1.

The electric wire sending means 2 sends the coated electric wire 100 along the longitudinal direction. According to the present embodiment, the electric wire sending means 2 sends the coated electric wire 100 along a horizontal plane wherein this sending direction shall be an X-direction. Furthermore, the vertical direction shall be a Z-direction while a direction orthogonal to the X-direction in the horizontal plane shall be a Y-direction. It is provided that the coated electric wire 100 sent by the electric wire sending means 2 is held downstream thereof by a suitable means so that the coated electric wire 100 may not be suspended downwards.

The circumferential cutter 3 includes a pair of first cutting blades 31, 32, a first approach/separation means for bringing close and away the pair of first cutting blades 31, 32, and a rotator for rotating said pair of first cutting blades 31, 32.

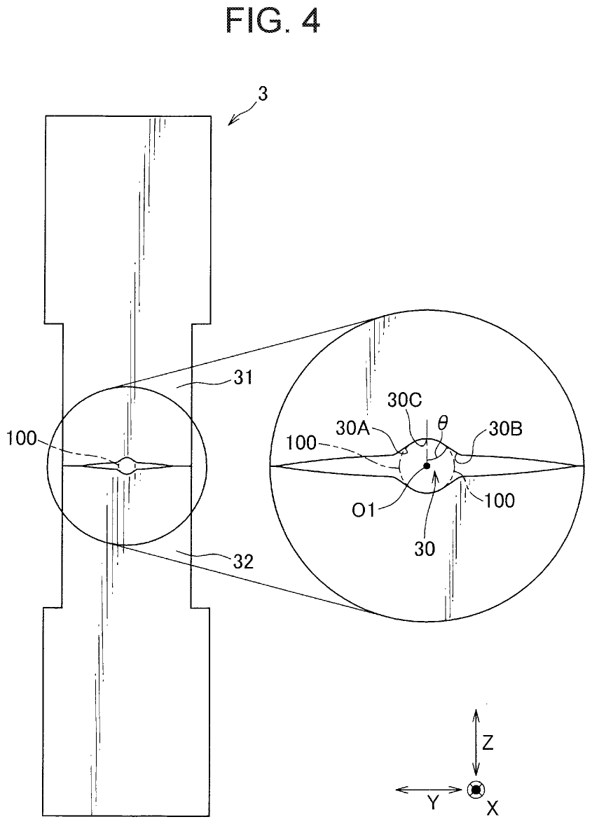

As shown in FIG. 4, for the pair of first cutting blades 31, 32, plate-shaped horizontal cutting edges along the YZ-plane are formed on opposed sides. In this context, while the pair of first cutting blades 31, 32 is in the shown example opposed in the Z-direction, they may be opposed in any opposition direction which is in the YZ-plane. Furthermore, the first approach/separation means brings close and/or away the pair of first cutting blades 31, 32 in their opposition direction.

When seen in the X-direction, recesses 30 are formed in the first cutting blades 31, 32 where the coated electric wire 100 is to be disposed in the recesses 30. The recesses 30 include two ramps 30A, 30B so that a width decreases towards the bottom 30C. The ramps 30A, 30B are tilted in relation to an opposition direction of the pair of first cutting blades 31, 32 (in the shown example the Z-direction), wherein the tilt angles θ are set e.g. to 30°, 45° and/or 60°. In this context, the tilt angles θ may be set in any suitable manner depending on an outer diameter of the coated electric wire 100 which is to be processed by the coating removing device 1 or depending on a thickness of the coating element 101. The first cutting blades 31, 32 are formed so that they have minimal thicknesses at inner edges of the recesses 30 and the thicknesses become larger in the direction away from the inner edges.

The first approach/separation means of the circumferential cutter 3 clamps the coated electric wire 100 radially by bringing close and away the pair of first cutting blades 31, 32 in their opposition direction. At this time, the coated electric wire 100 is positioned in the recesses 30 and additionally the inner edges of the recesses 30 and their vicinity intrude into the coating element 101. The first approach/separation means only needs to bring close the pair of first cutting blades 31, 32 depending on the diameter of the coated electric wire 100 and the thickness of the coating element 101 (i.e. depending on the outer diameter of the conductor section 102). In such a manner, the pair of first cutting blades 31, 32 comes close to each other so that it may not reach the conductor section 102 and the coating element 101 can be cut into a sufficient depth.

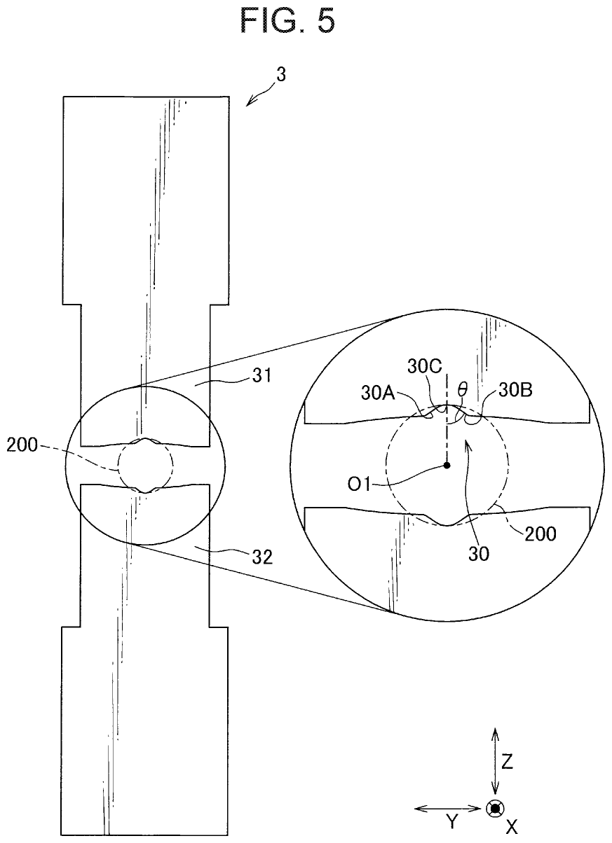

For example, when the coating element 101 should be removed for a relatively thin coated electric wire 100, the pair of first cutting blades 31, 32 is brought close as indicated in FIG. 4. On the other hand, when the coating element 201 should be removed for a relatively thick coated electric wire 200, the pair of first cutting blades 31, 32 is separated, as indicated in FIG. 5, further than for the coated electric wire 100.

The rotator of the circumferential cutter 3 rotates the pair of first cutting blades 31, 32 around a rotation axis O1 which extends through a center of a section of the coated electric wire 100 along the YZ-plane and extends along the X-direction. Namely, it is provided that a relative rotation of the coated electric wire 100 and the pair of first cutting blades 31, 32 is performed by the rotator.

Under the condition that the coated electric wire 100 is held by the pair of first cutting blades 31, 32 as described above, the rotator of the circumferential cutter 3 rotates the pair of first cutting blades 31, 32 around the rotation axis O1 so that the coating element 101 is cut along the circumferential direction. In this context, the pair of first cutting blades 31, 32 may be rotated in any suitable manner to be able to cut the coating element 101 over the entire periphery, wherein an example for the rotation angle may be 90°. In this context, the rotation angle for the pair of first cutting blades 31, 32 may also be determined depending on the thickness of the coated electric wire, for example, the rotation angle can be larger for the thick coated electric wire 200 than for the thin coated electric wire 100.

The coating removing device 1 is configured so that the coating element 101 can be cut at multiple different locations in the X-direction through the circumferential cutter 3 by displacing the coated electric wire 100 along the X-direction with the electric wire sending means 2. In this context, it may also be provided that the coating element 101 can be cut at multiple different locations in the X-direction by arranging an actuating means for displacing the pair of first cutting blades 31, 32 along the X-direction.

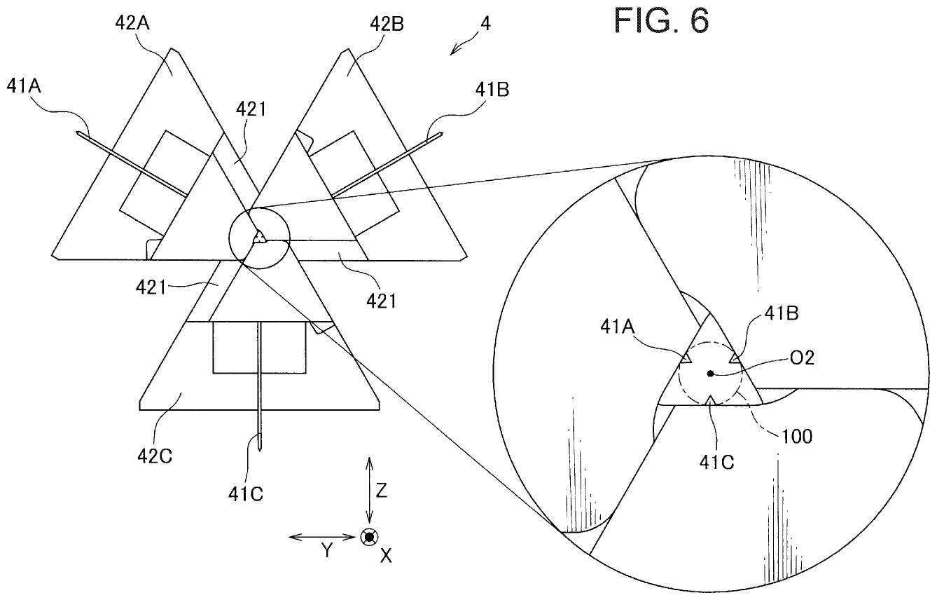

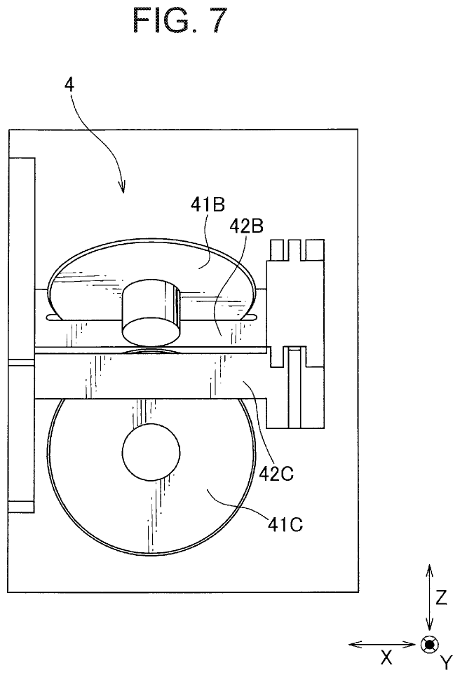

The longitudinal cutter 4 includes three second cutting blades 41A-41C, three movable units 42A-42C, a second approach/separation means and a linear translation unit as shown in FIGS. 6 and 7. The three second cutting blades 41A-41C are provided at the three respective movable units 42A-42C. The second cutting blades 41A-41C are disc-like shaped vertical blades.

The three movable units 42A-42C are formed in triangle shapes in the X-direction and can be brought close and away in relation to a predetermined virtual center O2 in the YZ-plane, wherein the second approach/separation means of the longitudinal cutter 4 bring close and away the three movable units 42A-42C. The virtual center O2 is a center in a section of the coated electric wire 100 along the YZ-plane. The three movable units 42A-42C come close or go away so that a distance between each of their tips and the virtual center O2 is equal to each other. The three second cutting blades 41A-41C protrude from the tips of the three movable units 42A-42C wherein their protruding extensions are equal to each other. That means that the depths to which the three second cutting blades 41A-41C intrude into the coating element 101 are equal to each other when holding the coated electric wire 100 with tips of the three movable unites 42A-42C.

A step 421 are formed on oblique sides of the movable unites 42A-42C so that they may not interfere with their neighboring movable unites 42A-42C. Namely, a step 421 which is concave when seen from upstream in the X-direction (the side facing the electric wire sending means 2) is formed on one of the both oblique sides while a step 421 which concave when seen from downstream in the X-direction is formed on the other oblique side. In this manner, it is provided that for two adjacent movable units, the step 421 which is concave when seen from upstream in the X-direction engages with the step 421 which concave when seen from downstream in the X-direction.

The second approach/separation means of the longitudinal cutter 4 may bring close the three movable unites 42A-42C in any suitable manner depending on the diameter of the coated electric wire 100 and the thickness of the coating element 101 (i.e. depending on the outer diameter of the conductor section 102). In this manner, the three second cutting blades 41A-41C come close to each other so that they may not reach the conductor section 102 and can cut the coating element 101 into a sufficient depth.

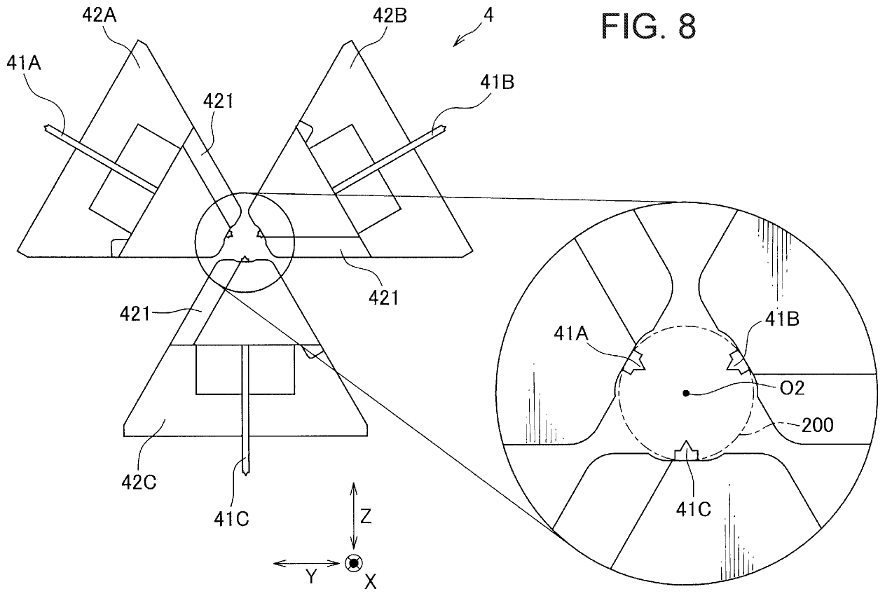

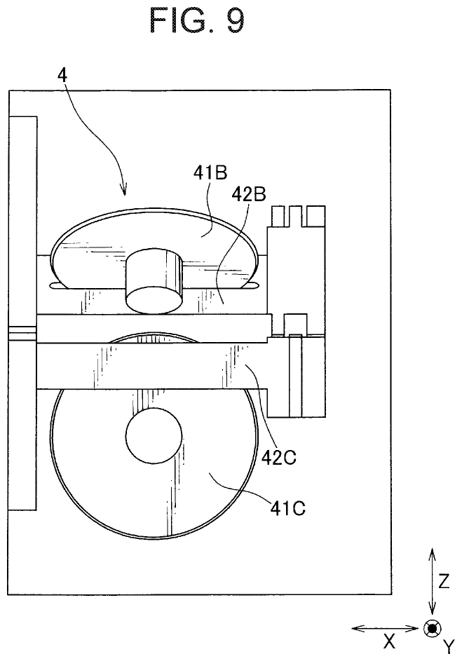

For example, when removing the coating element 101 for a relatively thin coated electric wire 100, the three movable unites 42A-42C are brought close as shown in FIGS. 6 and 7. On the other hand, when removing the coating element 201 for a relatively thick coated electric wire 200, the three movable unites 42A-42C are brought further away than for the coated electric wire 100, as shown in FIGS. 8 and 9.

The linear translation unit of the longitudinal cutter 4 displaces the three movable unites 42A-42C along the X-direction. This means that it is provided that a relative movement of the second cutting blades 41A-41C and the coated electric wire 100 is performed along the X-direction by means of the linear translation unit.

Under the condition that the second cutting blades 41A-41C are intruding into (in contact with) the coating element 101 by bringing close the three movable unites 42A-42C suitably as described above, the linear translation unit of the longitudinal cutter 4 moves the three movable units 42A-42C along the X-direction so as to cut the coating element 101 along the X-direction at three locations. In this context, a movement distance of the three movable units 42A-42C in the X-direction is substantially equal to a distance between two cut locations by means of the circumferential cutter 3 (two circumferential cut lines L2 as described below).

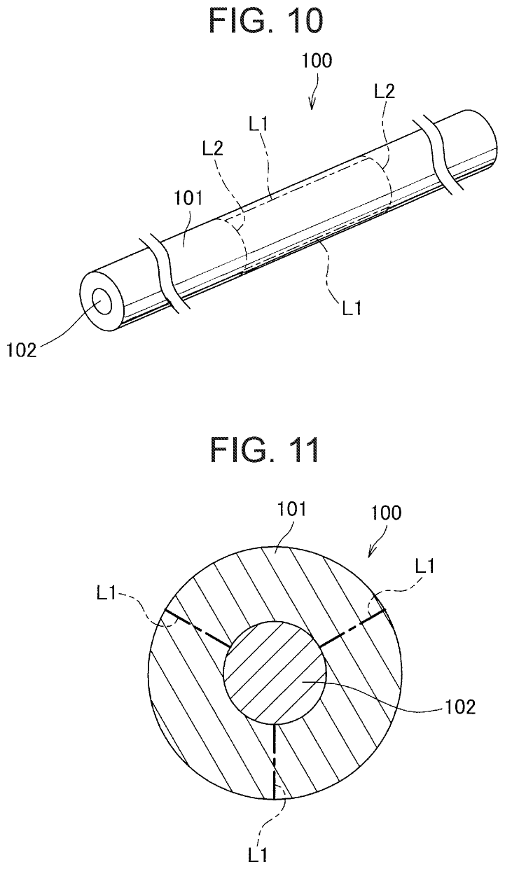

Now, a procedure for removing the coating element 101 by the coating removing device 1 shall be described. First, the coating removing device 1 cuts the coating element 101 at three locations by means of the longitudinal cutter 4 to form three longitudinal cut lines L1 (see FIGS. 10 and 11). Next, the coating removing device 1 forms two circumferential cut lines L2 in a sequential manner by means of the circumferential cutter 3. At this time, the coating element 101 may not be cut completely at the cut lines L1, L2. In this case, it is possible that the coating removing device 1 can cut the coating element 101 completely through breaking-off operation. The breaking-off operation may be any operation which apply a force on the coating element 101 in a direction other than in case of cutting, wherein an operation for relatively displacing the first cutting blades 31, 32 and the coated electric wire 100 along the X-direction and an operation for relatively rotating the movable units 42A-42C and the coated electric wire 100 is conceivable for example. Furthermore, it is also possible to provide an element dedicated for the breaking-off operation.

Forming the cut lines L1, L2 as described above results in three areas surrounded by the cut lines L1, L2 in the coating element 101. These areas of the coating element 101 can be separated from the rest. I.e., it causes a condition where a portion of the coating element 101 can be removed from the coated electric wire 100.

In this context, it is sufficient if the timing for cutting by the circumferential cutter 3 and the timing for cutting by the longitudinal cutter 4 are set in a suitable manner, wherein it is not limited to the above described order. Namely, it is possible to form two circumferential cut lines L2 by the circumferential cutter 3 and subsequently the longitudinal cut lines L1 by the longitudinal cutter 4. On the other hand, it is also possible to form one circumferential cut line L2 by the longitudinal cutter 3 and subsequently the longitudinal cut lines L1 by the longitudinal cutter 4, and additionally one circumferential cut line L2 by the circumferential cutter 3.

With the present embodiment as described above, the following effect can be achieved: the coating element 101 can be removed from the coated electric wire 100 between two circumferential cut lines L2 by cutting the coating element 101 at two locations with the circumferential cutter 3 to form the two circumferential cut lines L2 and by cutting it between the two circumferential cut lines L2 by the longitudinal cutter 4. As a consequence, the middle-stripping operation of the coating element 101 can be automated and improvement of the operation efficiency can be achieved.

Moreover, the fact that the circumferential cutter 3 includes a first approach/separation means and the first cutting blades 31, 32 include ramps 30A, 30B enables the first cutting blades 31, 32 to be forced into the coating element 101 depending on the thickness of the coated electric wire 100. This makes it unnecessary to exchange the first cutting blades 31, 32 depending on an electric wire diameter which achieves further improvement of the operation efficiency.

Furthermore, the fact that the longitudinal cutter 4 includes three movable units 42A-42C which come close to and go away from the virtual center O2, and the fact that additionally second cutting blades 41A-41C are provided on each of the three movable units 42A-42C enable the second cutting blades 41A-41C to be forced into the coating element 101 depending on the thickness of the coated electric wire 100. This makes it unnecessary to exchange the second cutting blades 41A-41C and/or the movable units 42A-42C depending on an electric wire diameter, which achieves further improvement of the operation efficiency.

Moreover, the coating removing device 1 by which the middle-stripping operation of the coating element 101 is automated as described above can be integrated into a line which is formed from an equipment for performing another process on the coated electric wire 100, i.e. can be in-line.

It is also to be noted that the present invention is not limited to the above described embodiments, but includes other configurations etc. which can achieve the object of the present invention, variations such as those shown below are also included in the present invention.

For example, while according to the above described embodiments, recesses 30 with ramps 30A, 30B are formed in the first cutting blades 31, 32, the first cutting blades do not need to have recesses, it is also possible for example to use planar first cutting blades and to adjust a distance between the first cutting blades so that the first cutting blades intrude into the coating element 101 depending on the thickness of the coated electric wire 100. Furthermore, it is possible to previously prepare first cutting blades dedicated for different thicknesses of the coated electric wire 100 or different thicknesses of the coating element 101 in order to exchange them in a suitable manner.

Furthermore, although according to the above described embodiments, second cutting blades 41A-41C are provided on each of the three movable units 42A-42C, it only needs to be provided on at least one of three or more movable units. Namely, it is also possible that a movable unit with a cutting blade is provided for cutting while a movable unit without a cutting blade is used for holding an electric wire.

Furthermore, the longitudinal cutter may be configured to include four or more movable units, wherein such a configuration can also cause the second cutting blade to intrude into the coating element 101 depending on the coated electric wire 100 in a similar manner as the above described embodiments. Moreover, it may be also provided that the second cutting blade and/or an element for bringing the second cutting blade in contact with the coating element 101 (e.g. an element for clamping the coated electric wire 100) can be exchanged, wherein the longitudinal cutter according to such a configuration do not need to include three or more movable units.

Moreover, while the circumferential cutter 3 according to the above described embodiments includes the rotator and is provided to rotate the pair of first cutting blades 31, 32, it is only necessary that the first cutting blades and the coated electric wire 100 may be rotated relative to each other, the coated electric wire 100 may be configured to be rotated, and it is also possible that both of the first cutting blades and the coating element are rotated in opposite directions.

Furthermore, while according to the above described embodiments, the longitudinal cutter 4 includes a linear translation unit and is configured to displace the second cutting blades 41A-41C along the X-direction, it is only necessary that the second cutting blades and the coated electric wire 100 may be displaced relative to each other along the X-direction, the coated electric wire 100 may be configured to be displaced along the X-direction (e.g. using the electric wire sending means 2 as the linear translation unit), and it is also possible that both of the second cutting blades and the coated electric wire 100 are displaced in opposite directions.

Although a further best configuration, method etc. for implementing the present invention are disclosed in the above description, the present invention is not limited to them. Namely, while the present invention is particularly shown and described mainly with regard to the specific embodiments, the above mentioned embodiments may be modified in forms, material characteristics, amounts or other detailed features in various manners by those skilled in the art without departing from the scope of the technical idea and purpose of the present invention. Therefore, the description with limited forms, material properties etc. according to the above disclosure is not limiting the present invention, but merely illustrative for easier understanding the present invention so that the description using names of the elements without a part or all of the limitations to their forms, material properties etc. is also included in the present invention.

### REFERENCE SIGNS LIST

1 coating removing device
3 circumferential cutter
31, 32 first cutting blades
30 recess
30A, 30B ramps
30C bottom
4 longitudinal cutter
41A-41C second cutting blades
42A-42C movable units
100 coated electric wire
101 coating element
A1 coated area
A2 conductor-exposed area
O1 rotation axis
O2 virtual center

What is claimed is:

1. A coating removing device for forming a conductor-exposed area by removing a part of a coating element on a coated electric wire so as to dispose said conductor-exposed area in a longitudinal direction between coated areas, the coating removing device comprising:
a circumferential cutter for cutting the coating element along a circumferential direction of the coated electric wire; and
a longitudinal cutter for cutting the coating element along the longitudinal direction;
wherein said circumferential cutter comprises a pair of first cutting blades for clamping the coated electric wire in a radial direction and a rotator for relatively rotating the pair of first cutting blades and the coated electric wire around a rotation axis along the longitudinal direction,
wherein said longitudinal cutter comprises at least one second cutting blade and a linear translation unit, said second cutting blade coming into contact with the coating element, and said linear translation unit relatively displacing the second cutting blade and the coated electric wire along the longitudinal direction, and
wherein the coating element is cut at two locations by the circumferential cutter and cut between said two locations by the longitudinal cutter.

2. The coating removing device according to claim 1, wherein a recess is formed in the first cutting blade in the longitudinal direction wherein the coated electric wire is to be disposed in the recess, and
wherein the recess comprises a ramp so that a width decreases towards a bottom.

3. The coating removing device according to claim 1, wherein the longitudinal cutter further comprises three or more movable units which come close and go away in relation to a predetermined virtual center, and
wherein the second cutting blade is provided on at least one of the three or more movable units.

4. The coating removing device according to claim 2, wherein the longitudinal cutter further comprises three or more movable units which come close and go away in relation to a predetermined virtual center, and
wherein the second cutting blade is provided on at least one of the three or more movable units.

5. A method for removing a coating to form a conductor-exposed area by removing a part of a coating element on a coated electric wire so as to dispose said conductor-exposed area in a longitudinal direction between coated areas, comprising:
a circumferential cutting step of cutting the coating element along a circumferential direction of the coated electric wire; and
a longitudinal cutting step of cutting the coating element along the longitudinal direction,
wherein in the circumferential cutting step, the coated electric wire is clamped by a pair of first cutting blades in a radial direction and the pair of first cutting blades and the coated electric wire are relatively rotated around a rotation axis along the longitudinal direction,
wherein in the longitudinal cutting step, at least one second cutting blade is brought into contact with the coating element and the second cutting blade and the coated electric wire are relatively displaced along the longitudinal direction, and
wherein the coating element is cut at two locations in the circumferential cutting step and the coating element is cut between said two locations in the longitudinal cutting step.
